(19) United States
(12) Patent Application Publication
(10) Pub. No.: US 2019/0320409 A1
(43) Pub. Date: Oct. 17, 2019

(54) ENHANCED CROWD-SOURCING NAVIGATION

(71) Applicants: Nir Dvorecki, Herzeliya (IL); Yuval Amizur, Kfar-Saba (IL); Leor Banin, Petach Tikva (IL); Ofer Bar-Shalom, Kiryat Ono (IL)

(72) Inventors: Nir Dvorecki, Herzeliya (IL); Yuval Amizur, Kfar-Saba (IL); Leor Banin, Petach Tikva (IL); Ofer Bar-Shalom, Kiryat Ono (IL)

(21) Appl. No.: 16/361,683

(22) Filed: Mar. 22, 2019

Related U.S. Application Data
(60) Provisional application No. 62/658,071, filed on Apr. 16, 2018.

(51) Int. Cl. H04W 64/00; H04W 4/024; H04W 4/02

(52) U.S. Cl. CPC H04W 64/006; H04W 4/023; H04W 4/024

(57) ABSTRACT

This disclosure describes systems, methods, and devices related to enhanced crowd-sourcing navigation. A device may identify user information received from the device, the user information corresponding to a trajectory of the device as determined by a navigation system of the device. The device may identify external information corresponding to the trajectory of the device, as determined by a wireless network. The device may determine navigation system error by comparing the user information to the external information. The device may cause to send information associated with the navigation system error to a server.

### CROSS-REFERENCE TO RELATED APPLICATION(S)

This application claims the benefit of U.S. Provisional Application No. 62/658,071, filed Apr. 16, 2018, the disclosure of which is incorporated herein by reference as if set forth in full.

### TECHNICAL FIELD

This disclosure generally relates to systems and methods for wireless communications and, more particularly, to enhanced crowd-sourcing navigation.

### BACKGROUND

Wireless devices are becoming widely prevalent and are increasingly requesting location determination for navigation purposes. These navigation requests rely on global navigation satellite system (GNSS), inertial sensors, Wi-Fi and other information to determine the location of the smart device. However, validation of such information usually is cumbersome and requires a great deal of field testing.

### BRIEF DESCRIPTION OF THE DRAWINGS

FIG. 1 is a network diagram illustrating an example network environment for enhanced crowd-sourcing navigation, in accordance with one or more example embodiments of the present disclosure.

FIG. 2 depicts an illustrative schematic diagram for an enhanced crowd-sourcing navigation system, in accordance with one or more example embodiments of the present disclosure.

FIG. 3 illustrates a flow diagram of an illustrative process for an enhanced crowd-sourcing navigation system, in accordance with one or more example embodiments of the present disclosure.

FIG. 4 illustrates a schematic map of a test location including a ground truth trajectory moving between access points (APs) in the test location, in accordance with one or more example embodiments of the present disclosure.

FIG. 5 illustrates Fine-Timing-Measurement (FTM) range errors from one of the APs in FIG. 4 as a function of the estimated non-line of sight (NLoS) probability from an NLoS mapping system, in accordance with one or more example embodiments of the present disclosure.

FIG. 6 illustrates FTM range errors cumulative distribution function (CDF) from one of the APs in FIG. 4 with and without a suggested NLoS mapping system, in accordance with one or more example embodiments of the present disclosure.

FIG. 7 illustrates a functional diagram of an exemplary communication station that may be suitable for use as a user device, in accordance with one or more example embodiments of the present disclosure.

FIG. 8 illustrates a block diagram of an example machine upon which any of one or more techniques (e.g., methods) may be performed, in accordance with one or more example embodiments of the present disclosure.

FIG. 9 is a block diagram of a radio architecture in accordance with some examples.

FIG. 10 illustrates an example front-end module circuitry for use in the radio architecture of FIG. 9, in accordance with one or more example embodiments of the present disclosure.

FIG. 11 illustrates an example radio IC circuitry for use in the radio architecture of FIG. 9, in accordance with one or more example embodiments of the present disclosure.

FIG. 12 illustrates an example baseband processing circuitry for use in the radio architecture of FIG. 9, in accordance with one or more example embodiments of the present disclosure.

### DETAILED DESCRIPTION

Example embodiments described herein provide certain systems, methods, and devices for enhanced crowd-sourcing navigation. The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Smart devices, such as smart phones and smart watches, are commonly used for navigation. Smart device navigation can rely on global navigation satellite system (GNSS), inertial sensors, Wi-Fi and other information to determine the location of the smart device. Because of diverse environments and use cases, the validation and development of such systems usually involves a great deal of field testing.

Traditionally, such testing and validation required a ground truth reference (GTR) employed in the field. Traditional field testing requires a tester to move along a trajectory with the navigating device and a GTR device. The estimated trajectory of the navigation device can be compared to the highly accurate base measurement of the GTR device. The resulting error exhibited by the navigating device can be assessed to determine navigation system performance.

This process can be cumbersome or even impractical. GTR devices are heavy and not suitable in certain environments. Testing in multiple locations around the globe can be expensive and/or slow. Moreover, the navigation system cannot be tested across all possible use cases for actual users.

The need to quickly validate and develop navigation systems code in the field, without relying on GTR devices, is constantly increasing. As updates, patches, and new systems become more rapidly available, the need for faster and easier validation and testing has become necessary.

A current alternative to using GTR devices for navigation system error determination is to post-process the measurements taken during test time and to construct a semi-accurate base measurement at a later time. However, post-processing requires significant knowledge of the tested region and several assumptions about the inner workings of the navigation filter used to complete post-processing. Post processing is not robust or flexible. Post-processing requires high throughput (network, memory and CPU resources) and violates the privacy of the users because of the nature of the data transferred.

Smart device use of ranging from WiFi Access Points (APs) through IEEE 802.11az Fine-Timing-Measurement (FTM) can be restricted in certain environments, such as those with high non-line-of-sight (NLoS) conditions. Often, NLoS cases result in estimated ranges from the AP greater than their true values.

Currently, network-wide sharing protocols for APs lack mitigation for NLoS error. Use of simple heuristics for positioning ignores or de-weights range measurements that are significantly larger than expected by the positioning engine. This ignores the geometry of the NLoS error. As a result, the smart device can be unable to generalize to intermediate locations and/or previously unseen APs. Moreover, traditional methods ignore information from distant APs, thus requiring many more APs to achieve the same yield.

Example embodiments of the present disclosure relate to systems, methods, and devices for enhanced crowd-sourcing navigation.

Crowd-sourcing may be utilized to test and validate navigation systems for accuracy. For example, individual or aggregate location data determined by a navigation system associated with one or more user devices may be compared to one or more external measurements not determined by the navigation system of the one or more user devices to correlate accuracy and measure performance of the navigation system without the use of a dedicated GTR device.

In one or more embodiments, enhanced crowd-sourcing navigation can be used to determine navigation system error. Specifically, enhanced crowd-sourcing navigation can determine navigation system error between navigation systems of local user devices and external information determined by a wireless network, including for example, one or more cellular and/or WiFi access points (APs). The use of enhanced crowd-sourcing navigation can eliminate the requirement of dedicated GTR devices for purpose of testing and validating navigation systems.

In one or more embodiments, an enhanced crowd-sourcing navigation system may facilitate crowd-sourcing data from many users to measure the overall performance of the navigation system. Data from user trajectories can be compiled to measure overall system performance. Each trajectory can include, for example, a single navigation solution. The individual trajectories can be collectively assessed and averaged to reduce noise and determine aggregate navigation system error. In an embodiment, crowd-sourcing data used for validating navigation system performance can include at least 100 unique user trajectories. Use of many unique user trajectories can reduce noise exhibited by each individual trajectory. Thus, overall system performance can be used to improve the navigation system and create updates and patches for enhanced accuracy and precision of the navigation system without use of a dedicated GTR device.

In one or more embodiments, an enhanced crowd-sourcing navigation system may use system performance measurements to quickly analyze and improve new code versions. Methods in accordance with embodiments described herein may not require private information from the user devices regarding specific position or heading associated with individual users. In such a manner, validation can be performed without sacrificing user privacy.

In one or more embodiments, improvement to the navigation system can occur at least partially using automated optimization. For example, improvement can be determined as a reinforcement learning/optimization problem.

In one or more embodiments, enhanced crowd-sourced navigation can be performed on the user devices directly. The measure of the performance can then be transferred to a remote location, such as a remote server, to collect and analyze the performance data.

In one or more embodiments, an enhanced crowd-sourced navigation system may receive user information corresponding to trajectories of one or more user devices as determined by navigation systems of the one or more user devices. The user information can be determined, for example, using GNSS, sensors contained in the user devices, or both. The enhanced crowd-sourced navigation system may further receive external information corresponding to trajectories of the one or more user devices, as determined by cellular and/or WiFi access points (APs), and determine navigation system error between the user information and the external information. Importantly, the user information and external information are determined independently of one another. More particularly, the user information and external information are subject to different errors from one another facilitated by different location determination processes. Whereas the user devices rely on the navigation system for determining location, the external information is provided by an external source different than the user devices. In an embodiment, determination of the navigation system error can utilize KL-divergence to compare the user information to the external information. In a further embodiment, determination of the navigation system error can utilize mean-squared error (MSE) to find absolute error between the user information and external information. In yet another embodiment, navigation system error can be determined using mean-absolute error (MAE). By capturing information from crowd-sourced navigation system usage, individual noise associated with each user device can be reduced, and aggregate navigation system error can be computed with low noise relative to individual user error.

In one or more embodiments, an enhanced crowd-sourcing navigation system may enable fast validation and development of new code versions for the navigation algorithms by measuring their performance in the field. New code versions for the navigation algorithm can be A/B tested in the field to determine which update is more accurate. This may enable faster, unbiased feedback for the performance of new code versions, without the need to conduct large scale testing with dedicated GTR devices.

In one or more embodiments, navigation system error can be determined using parameter vectors randomized around a default value. Configuration parameter vectors in the navigation system can be randomized around a default value. The navigation system performance measures and noise can be processed around the most promising parameters without explicitly determining which situations cause navigation system error.

Through crowd sourcing, it is possible to build a map estimating the expected probability of a line of sight (LoS) blocker disposed on the path between a station (STA) and an AP. By mapping multiple locations and APs, it is possible to pinpoint LoS blockers and use the associated data to correct positioning errors for STA positions and APs in that environment. The resulting NLoS errors can be mapped and accounted for to increase accuracy and yield of the positioning engine.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

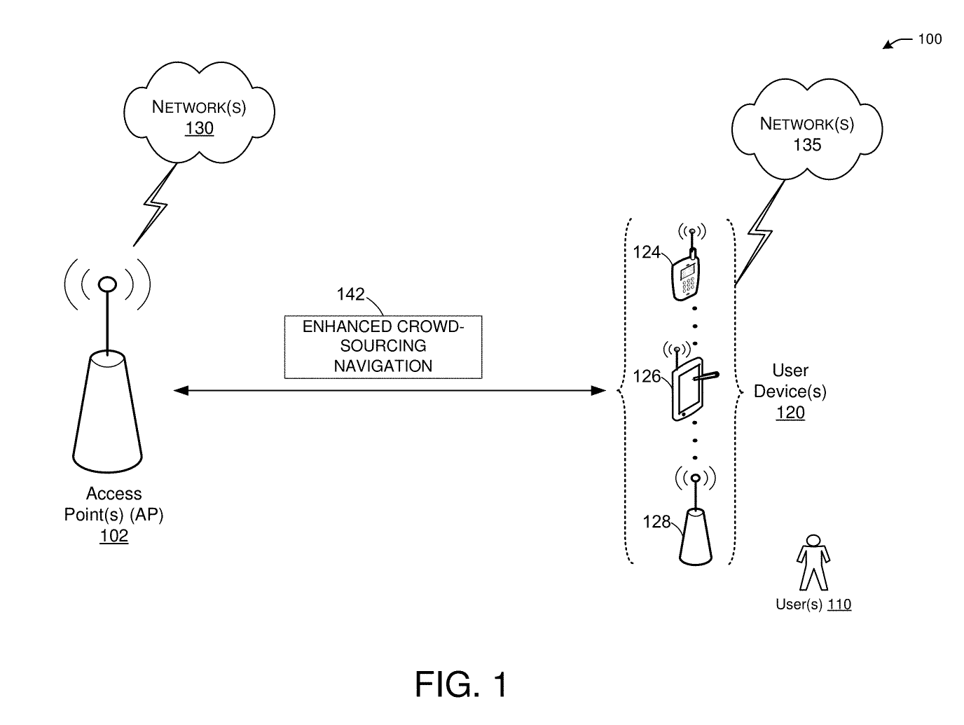

FIG. 1 is a network diagram illustrating an example network environment of enhanced crowd-sourcing navigation, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

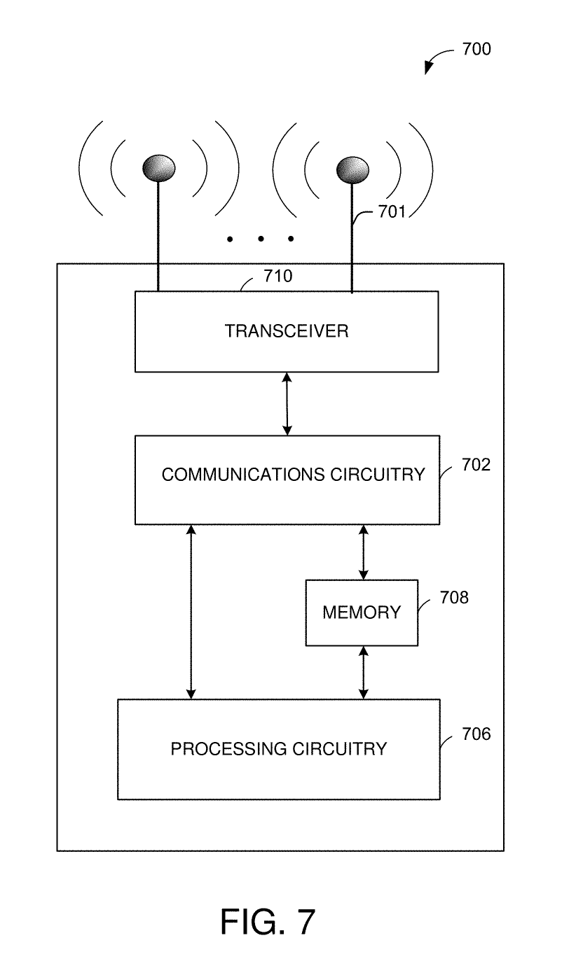

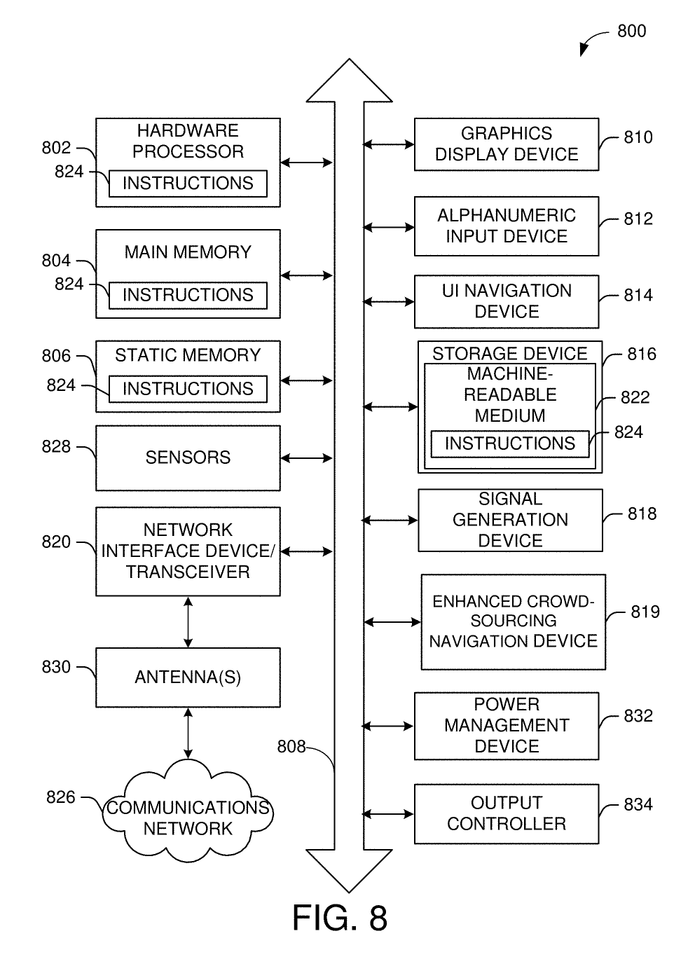

In some embodiments, the user devices 120 and the AP 102 may include one or more computer systems similar to that of the functional diagram of FIG. 7 and/or the example machine/system of FIG. 8.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static, device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one or more embodiments, and with reference to FIG. 1, one or more APs 102 may perform enhanced crowd-sourcing navigation 142 with one or more user devices 120. Enhanced crowd-sourcing navigation 142 may be utilized to test and validate navigation systems for accuracy. For example, individual or aggregate location data determined by a navigation system associated with one or more user devices 120 may be compared to one or more external measurements not determined by the navigation system of the one or more user devices to correlate location accuracy and measure performance of the navigation system without the use of a dedicated ground truth reference (GTR) device. In an embodiment, the external measurements can be performed by a wireless network 130, including for instance, the AP 102.

In one or more embodiments, crowd-sourcing navigation 142 may permit navigation system A/B testing without requiring repeat GTR device usage. In certain embodiments, several versions of the navigation system can be implemented and tested to compare performance metrics of the navigation system updates. In one embodiment, a single user device 120 can be used to test multiple versions of the navigation system. For example, the single user device 120 can test at least two versions, at least three versions, or at least four versions of the navigation system simultaneously.

In one or more embodiments, an enhanced crowd-sourcing navigation system may facilitate a method to crowdsource data in order to measure the performance of the navigation system. Through analyzing user data corresponding with trajectories of user devices running the navigation system, the performance of the navigation solution can be tested and validated. Each trajectory analyzed can include a discrete user device operating on a discrete navigation solution (e.g., a single device on a single path). Using information from the trajectories of many devices, the enhanced crowd-sourcing navigation 142 can determine aggregate (overall) navigation system error.

In one or more embodiments, local noise may be mitigated by analyzing at least 100 unique trajectories, at least 200 unique trajectories, at least 1000 unique trajectories, or at least 10,000 unique trajectories. The information in the unique trajectories can be analyzed and averaged using one or more processes described herein. Through averaging the performance of navigation solutions across multiple user devices as compared to external sources, enhanced crowd-sourcing navigation 142 can be asymptotically invariant to the variances in the measurement noise. That is, global symmetry of particular problems may be accounted for and elevated local noise can be mitigated. In such a manner, large local noise variances may not affect the asymptotic behavior of the enhanced crowd-sourcing navigation 142. Moreover, the enhanced crowd-sourcing navigation 142 may be asymptotically invariant to local biases in measurements typical of wireless network (e.g., WiFi) measurements.

In one or more embodiments, the enhanced crowd-sourcing navigation system may use direct performance estimation from external measurements, such as from one or more cellular and/or WiFi APs to analyze enhanced crowd-sourcing navigation 142. Because of privacy concerns, certain data is not available for enhanced crowd-sourcing navigation 142. Thus, enhanced crowd-sourcing navigation 142 may rely only on available information.

In a typical navigation system, measurements are regularly driven into a navigation processor, such as a Kalman filter. Such measurements are assumed to be uncorrelated and with a known measurement model. The measurements model is a deterministic, known function of the true navigating device state (position, velocity, etc.) plus some unknown noise, which is uncorrelated with previous measurements. This solution is cumbersome and difficult to rapidly implement. To the contrary, embodiments described herein may check the navigation solution directly, e.g., on the user device, against the external measurements to assess performance. The measure of the performance may then be transferred from each user to a server that collects the data. Data analysis may be performed to enhance operative performance.

An enhanced crowd-sourcing navigation system may define a plurality of performance measures, such as for instance, two performance measures (though it is possible to construct others). An enhanced crowd-sourcing navigation system may focus on the system's position estimation performance. Similar results may be achieved for velocity and heading estimations. For assessing how well the navigation solution predicts the true position, an enhanced crowd-sourcing navigation system may use KL-divergence, which is a typical measure of similarity between two distributions (the true distribution versus the one estimated by the system). For measuring the system's absolute error in estimating the position, an enhanced crowd-sourcing navigation system may use the mean-squared error (MSE). For example, assuming the simplest case, in which the system receives measurements that directly tells it about its current position. This can be accomplished using Wi-Fi, GNSS or other methods. In an embodiment:

yᵢ=xᵢ+nᵢ

where yᵢ is the measurement, xᵢ is the 2D or 3D position of the system and n₁ is the noise on the measurement, whose covariance matrix is finite and denoted by Rᵢ. Since the measurements are uncorrelated with the error of the navigation system, before the system processes that measurement, an unbiased estimate of the MSE may be obtained:

$$= \frac{1}{N} {\sum }_{i} {( {y}_{i} - {\hat{x}}_{i} )}^{T} ( {y}_{i} - {\hat{x}}_{i} ) - trace ( {R}_{i} )$$

where \hat{x}ᵢ is the position estimated by the navigating device and N is the total number of measurements.

For a navigation system using a Kalman filter, an unbiased estimate of the KL-divergence (up to a constant) may be obtained:

$$\hat{D} = \frac{1}{N} {\sum }_{i} log ( \vert {\hat{C}}_{i} \vert ) + {( {y}_{i} - {\hat{x}}_{i} )}^{T} {{\hat{C}}^{- 1}}_{i} ( {y}_{i} - {\hat{x}}_{i} ) - trace ( {\hat{C}}^{- 1} {}_{i}^{}{R}{}_{i}^{} )$$

where Ĉᵢ is the Kalman's position covariance matrix.

A similar result can be derived for the general case of measurements that are approximately linear in the true position, such as from GNSS.

In another embodiment, the enhanced crowd-sourcing navigation system may use mean-absolute error (MAE), error quantiles, or other performative measures of navigation system error.

In one or more embodiments, an enhanced crowd-sourcing navigation system may use crowd-sourcing to improve the navigation system. The above measures of performance (e.g., MSE and KL-divergence) can be used as indicators in order to improve the navigation system. In one or more embodiments, navigation system improvement can occur automatically. In an embodiment, improvements to one or more code versions can be done automatically by considering the improvement problem as a reinforcement learning/optimization problem in which the cost signal is given by the MSE or the KL-divergence. In an embodiment, a demo code version of the navigation system may be released to a group of test users and one or more performative measurements (e.g., MSE and KL-divergence) can be compared to a control group using the default version. In one or more embodiments, context information (e.g., if it is known when the user is driving, cycling, walking, etc.) can be received by the navigation system. In an embodiment, context information can be used to measure performance separately for each use case. In such a manner, code development can focus on the more problematic or difficult use cases.

In one or more embodiments, an enhanced crowd-sourcing navigation system may run two or more competing code versions on the same user device simultaneously and measure the performance for each. The user may be given the solution of the default code version. The secondary code version may be computed by the enhanced crowd-sourcing navigation system but may not be displayed to the user. Thus, the risk of exposing users to bad code versions on the user devices is reduced or mitigated. Moreover, this method may require fewer users, since its variance is significantly lower than methods in which different users run different code versions in different locations.

It is understood that the above descriptions are for purposes of illustration and are not meant to be limiting.

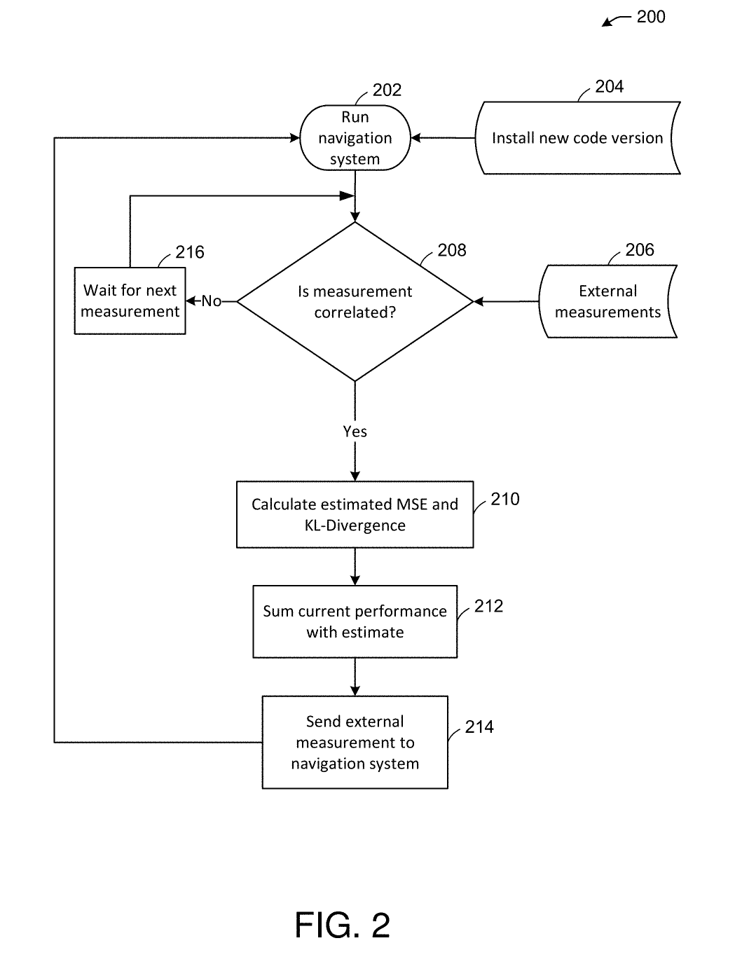

FIG. 2 depicts an exemplary flow chart 200 describing an algorithm associated with a crowd-sourcing navigation system in accordance with an embodiment. The algorithm may initiate by running 202 the navigation system. In certain instances, the navigation system may receive 204 a new update from a server with a new code version or configuration. In an embodiment, the new update may be dispatched to a test group of user devices. Once the appropriate measurements from an external source are received 206 (e.g. from Wi-Fi positioning), the algorithm may check if they are correlated 208 to previous measurements. In an embodiment, correlation 208 to previous data can occur with simple heuristics that depend on the nature of the measurement source used. In Wi-Fi positioning, for example, it may be enough to check the distance between the current received measurement and the previous one used. If there is no correlation, 208, the algorithm can wait 216 for the next measurement and again check for correlation 208 until correlation occurs. Once a correlated measurement is received, estimated mean-squared error (MSE), KL-Divergence, or mean-absolute error (MAE) can be calculated 210. The navigation system error can then be determined by summing (comparing) 212 the navigation system performance to the estimated performance. In an embodiment, these measurement can then be sent 214 to the navigation system in order to improve the navigation system. Once the navigation concludes (not shown in the figure), the two estimated values of the MSE and KL-divergence may be sent to the server. In an embodiment, the algorithm may again run 202 the navigation system. For example, a device associated with the navigation system can input a new trajectory (e.g., a path for navigation), causing the navigation system to run 202 and validate navigation system error.

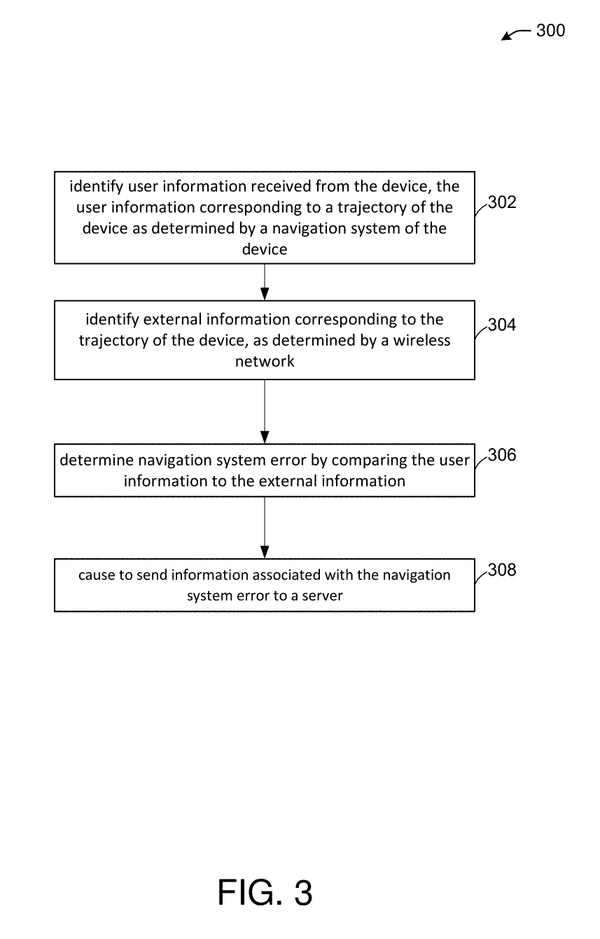

FIG. 3 illustrates a flow diagram of illustrative process 300 for an illustrative enhanced crowd-sourcing navigation system, in accordance with one or more example embodiments of the present disclosure.

At block 302, a device may identify user information received from the device, the user information corresponding to a trajectory of the device as determined by a navigation system of the device. In some examples, the trajectory may include information related to an estimated path of travel of the device. In some examples, the user information may be based on a global navigation satellite system (GNSS) or sensors associated with the user devices.

At block 304, the device may identify external information corresponding to the trajectory of the device, as determined by a wireless network. In some examples, the wireless network may comprise one or more WiFi devices or cellular networks.

At block 306, the device may determine navigation system error by comparing the user information to the external information. In some examples, the navigation system error may be determined without the use of a dedicated ground truth reference (GTR) device. In some examples, the navigation system error defines a performance aspect of the navigation system. In some examples, the navigation system error may be determined using at least one of KL-Divergence, mean-squared error (MSE), and mean-absolute error (MAE).

At block 308, the device may cause to send information associated with the navigation system error to a server.

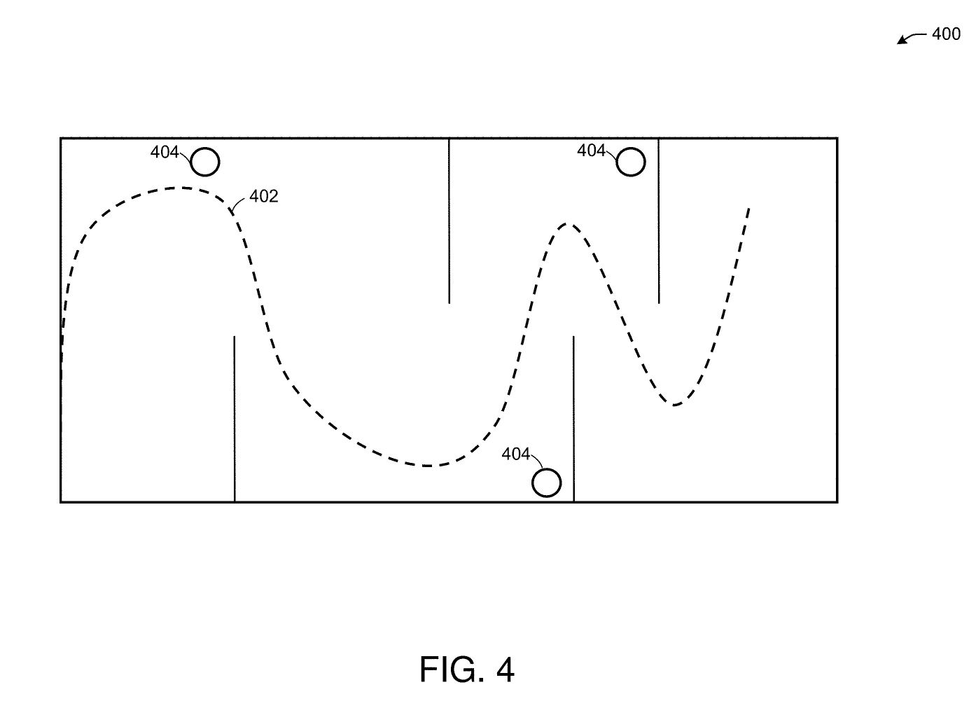

FIG. 4 illustrates a schematic map of a test location 400 including a ground truth trajectory 402 moving between access points (APs) 404 in the test location 400, in accordance with one or more example embodiments of the present disclosure. By crowd-sourcing positions and range residuals from clients, an estimated map determining expected probability of line of sight (LoS) blockers can be constructed between a client and an AP. By mapping multiple locations and APs, it may be possible to pinpoint LoS blockers and use that data to correct positioning errors for positions and APs in the test location 400.

In one or more embodiments, WiFi Fine-Timing-Measurement (FTM) can be used for indoor positioning. Protocols for positioning can rely on measuring the round-trip delay time (RTT) between the AP and the client device. This can produce a range from each nearby AP to the client device. The client or network can then use the estimated ranges as inputs to the navigation processes, such as a Kalman filter, to provide the position of the client.

The main error source of WiFi FTM range measurements is the presence of non-line of sight (NLoS) or difficult multipath conditions. Many indoor environments contain metallic walls that reflect WiFi signal. Moreover, concrete walls completely block WiFi signal. Sometimes typical error caused by multipath of NLoS can be in the order of several meters. Such an error can be smoothed by navigation Kalman filters by using the previous known position of the user and by combining with different APs, since the measurement noises are roughly uncorrelated. In other situations, the range error can be catastrophic if not properly filtered. When measuring the range from an AP with which the user has no LoS, the resulting range error can be larger than ten meters. If used as-is, such a measurement can cause the navigation solution to diverge. While outlier filtering and de-weighting techniques can be used, both methods fail in cases where few APs have direct LoS to the user.

In one or more embodiments, systems in accordance with one or more embodiments described herein can model the NLoS error by transferring the measured ranges to a central server of the AP's network for processing. The process can be split into three parts. Obtaining initial positions estimates for the client device, along with the measured FTM ranges between the client and each AP in the vicinity. A server collects the measurements and processes them by modeling the propagation of the WiFi signals and comparing them to the actual measured ranges. Given previous sets of measurements, new user and/or AP positions can be assess by either predicting if a NLoS is expected for that new user and/or AP position, or by directly fitting a range error estimator. Unlike WiFi Received Signal Strength Indicator (RSSI), NLoS mapping is particularly effective for indoor environments.

In one or more embodiments, a key difference between the NLoS mapping method and RSSI fingerprinting is in the ability of NLoS mapping to generalize to previously unseen locations within the indoor environment. Modeling how RSSI changes as a function of the user position is difficult. Typical implementations assume a spatially decaying correlation between the RSSI measured in different positions. In complex environments, such as an indoor office with many cubicles, the correlation can decay so fast that the RSSI has to be sampled at each and every cubicle. In addition, the properties of the correlation can change drastically between different parts of the office (e.g. between the cubicles and the open cafeteria area). In certain instances, NLoS mapping may be able to easily extrapolate between large distances by using geometric constraints. Given a measurement between a user and an AP that has no LoS component, we might expect all other users positioned further away from the AP, but on the same line going from the AP to the measured user, to also see NLoS to that AP. The converse is also true—if a user has LoS to an AP, then in all positions between the measured user and the AP one should also have LoS. A second order correction can take into account possible locations of reflectors and learn according to the measured ranges from which reflector the WiFi signal propagated. NLoS mapping may require fewer positions to be measured and can generalize farther away than RSSI fingerprinting.

In one or more embodiments, NLoS mapping can be performed without the use of a ground truth. When the user is close to an AP, the WiFi FTM measurement is usually of high quality because the probability of NLoS is very small. Therefore, the position of the user is known with good accuracy. By measuring the NLoS to distant APs, it may be possible to create the NLoS map, which should be enough to generalize to in-between positions.

In certain instances, WiFi FTM LoS is mostly blocked by large concrete or metal walls. Therefore, once an indoor environment is measured, the NLoS map remains roughly constant. This is in contrast to RSSI, which can change drastically by moving a metallic wall of a cubical.

In addition to directly modeling the NLoS errors of existing APs, NLoS mapping can also be used to predict the errors seen by candidate positions. This enables installing APs at optimal locations and providing better yield with a smaller number of APs.

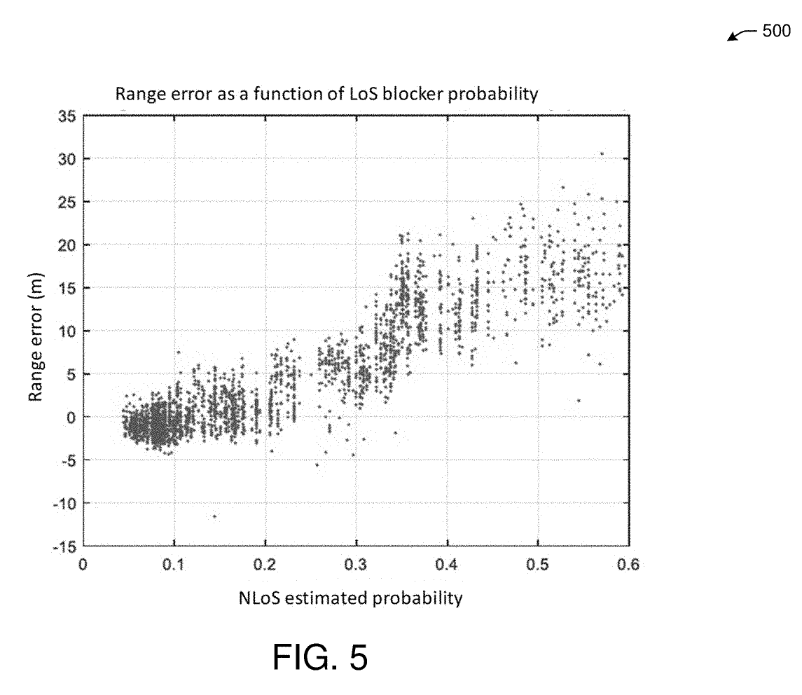

FIG. 5 illustrates an FTM range errors plot 500 from one of the APs in FIG. 4 as a function of the estimated non-line of sight (NLoS) probability from an NLoS mapping system, in accordance with one or more example embodiments of the present disclosure.

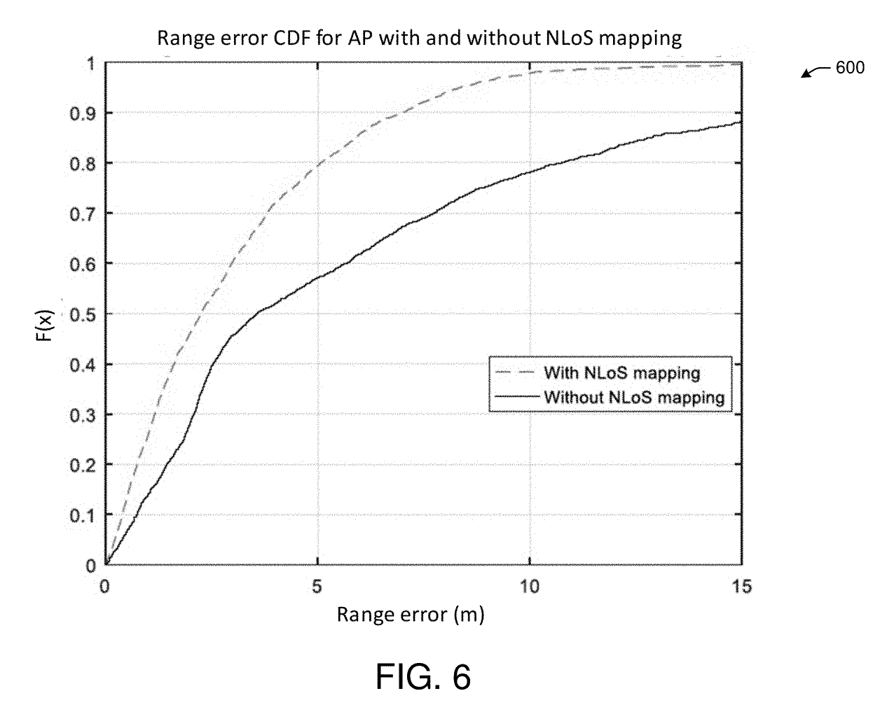

FIG. 6 illustrates FTM range errors cumulative distribution function (CDF) plot 600 from one of the APs in FIG. 4 with and without a suggested NLoS mapping system, in accordance with one or more example embodiments of the present disclosure.

It is understood that the above descriptions are for purposes of illustration and are not meant to be limiting.

FIG. 7 shows a functional diagram of an exemplary communication station 700 in accordance with some embodiments. In one embodiment, FIG. 7 illustrates a functional block diagram of a communication station that may be suitable for use as an AP 102 (FIG. 1) or user device 120 (FIG. 1) in accordance with some embodiments. The communication station 700 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 700 may include communications circuitry 702 and a transceiver 710 for transmitting and receiving signals to and from other communication stations using one or more antennas 701. The communications circuitry 702 may include circuitry that can operate the physical layer (PHY) communications and/or medium access control (MAC) communications for controlling access to the wireless medium, and/or any other communications layers for transmitting and receiving signals. The communication station 700 may also include processing circuitry 706 and memory 708 arranged to perform the operations described herein. In some embodiments, the communications circuitry 702 and the processing circuitry 706 may be configured to perform operations detailed in FIGS. 1-6.

In accordance with some embodiments, the communications circuitry 702 may be arranged to contend for a wireless medium and configure frames or packets for communicating over the wireless medium. The communications circuitry 702 may be arranged to transmit and receive signals. The communications circuitry 702 may also include circuitry for modulation/demodulation, upconversion/downconversion, filtering, amplification, etc. In some embodiments, the processing circuitry 706 of the communication station 700 may include one or more processors. In other embodiments, two or more antennas 701 may be coupled to the communications circuitry 702 arranged for sending and receiving signals. The memory 708 may store information for configuring the processing circuitry 706 to perform operations for configuring and transmitting message frames and performing the various operations described herein. The memory 708 may include any type of memory, including non-transitory memory, for storing information in a form readable by a machine (e.g., a computer). For example, the memory 708 may include a computer-readable storage device, read-only memory (ROM), random-access memory (RAM), magnetic disk storage media, optical storage media, flash-memory devices and other storage devices and media.

In some embodiments, the communication station 700 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 700 may include one or more antennas 701. The antennas 701 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 700 may include one or more of a keyboard, a display, a non-volatile memory port, multiple antennas, a graphics processor, an application processor, speakers, and other mobile device elements. The display may be an LCD screen including a touch screen.

Although the communication station 700 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 700 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 700 may include one or more processors and may be configured with instructions stored on a computer-readable storage device memory.

FIG. 8 illustrates a block diagram of an example of a machine 800 or system upon which any one or more of the techniques (e.g., methodologies) discussed herein may be performed. In other embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environments. The machine 800 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a power management device 832, a graphics display device 810, an alphanumeric input device 812 (e.g., a keyboard), and a user interface (UI) navigation device 814 (e.g., a mouse). In an example, the graphics display device 810, alphanumeric input device 812, and UI navigation device 814 may be a touch screen display. The machine 800 may additionally include a storage device (i.e., drive unit) 816, a signal generation device 818 (e.g., a speaker), an enhanced crowd-sourcing navigation device 819, a network interface device/transceiver 820 coupled to antenna(s) 830, and one or more sensors 828, such as a global positioning system (GPS) sensor, a compass, an accelerometer, or other sensor. The machine 800 may include an output controller 834, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within the static memory 806, or within the hardware processor 802 during execution thereof by the machine 800. In an example, one or any combination of the hardware processor 802, the main memory 804, the static memory 806, or the storage device 816 may constitute machine-readable media.

The enhanced crowd-sourcing navigation device 819 may carry out or perform any of the operations and processes (e.g., process 300) described and shown above. For example, the crowd-sourcing navigation device 819 may be used to determine navigation system error. Specifically, enhanced crowd-sourcing navigation can determine navigation system error between navigation systems of local user devices and external information determined by a wireless network, including for example, one or more cellular and/or WiFi access points (APs). The use of enhanced crowd-sourcing navigation can eliminate the requirement of dedicated GTR devices for purpose of testing and validating navigation systems.

The enhanced crowd-sourcing navigation device 819 may facilitate crowd-sourcing data from many users to measure the overall performance of the navigation system. Data from user trajectories can be compiled to measure overall system performance. Each trajectory can include, for example, a single navigation solution. The individual trajectories can be collectively assessed and averaged to reduce noise and determine aggregate navigation system error. In an embodiment, crowd-sourcing data used for validating navigation system performance can include at least 100 unique user trajectories. Use of many unique user trajectories can reduce noise exhibited by each individual trajectory. Thus, overall system performance can be used to improve the navigation system and create updates and patches for enhanced accuracy and precision of the navigation system without use of a dedicated GTR device.

The enhanced crowd-sourcing navigation device 819 may use system performance measurements to quickly analyze and improve new code versions. Methods in accordance with embodiments described herein may not require private information from the user devices regarding specific position or heading associated with individual users. In such a manner, validation can be performed without sacrificing user privacy. Improvement to the navigation system can occur at least partially using automated optimization. For example, improvement can be determined as a reinforcement learning/optimization problem.

The enhanced crowd-sourcing navigation device 819 may be performed on the user devices directly. The measure of the performance can then be transferred to a remote location, such as a remote server, to collect and analyze the performance data.

The enhanced crowd-sourcing navigation device 819 may receive user information corresponding to trajectories of one or more user devices as determined by navigation systems of the one or more user devices. The user information can be determined, for example, using GNSS, sensors contained in the user devices, or both. The enhanced crowd-sourced navigation system may further receive external information corresponding to trajectories of the one or more user devices, as determined by cellular and/or WiFi access points (APs), and determine navigation system error between the user information and the external information. Importantly, the user information and external information are determined independently of one another. More particularly, the user information and external information are subject to different errors from one another facilitated by different location determination processes. Whereas the user devices rely on the navigation system for determining location, the external information is provided by an external source different than the user devices. In an embodiment, determination of the navigation system error can utilize KL-divergence to compare the user information to the external information. In a further embodiment, determination of the navigation system error can utilize mean-squared error (MSE) to find absolute error between the user information and external information. In yet another embodiment, navigation system error can be determined using mean-absolute error (MAE). By capturing information from crowd-sourced navigation system usage, individual noise associated with each user device can be reduced, and aggregate navigation system error can be computed with low noise relative to individual user error.

The enhanced crowd-sourcing navigation device 819 may enable fast validation and development of new code versions for the navigation algorithms by measuring their performance in the field. New code versions for the navigation algorithm can be A/B tested in the field to determine which update is more accurate. This may enable faster, unbiased feedback for the performance of new code versions, without the need to conduct large scale testing with dedicated GTR devices.

In one or more embodiments, navigation system error can be determined using parameter vectors randomized around a default value. Configuration parameter vectors in the navigation system can be randomized around a default value. The navigation system performance measures and noise can be processed around the most promising parameters without explicitly determining which situations cause navigation system error.

It is understood that the above are only a subset of what the enhanced crowd-sourcing navigation device 819 may be configured to perform and that other functions included throughout this disclosure may also be performed by the enhanced crowd-sourcing navigation device 819.

While the machine-readable medium 822 is illustrated as a single medium, the term “machine-readable medium” may include a single medium or multiple media (e.g., a centralized or distributed database, and/or associated caches and servers) configured to store the one or more instructions 824.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 800 and that cause the machine 800 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device/transceiver 820 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 820 may include one or more physical jacks (e.g., Ethernet, coaxial, or phone jacks) or one or more antennas to connect to the communications network 826. In an example, the network interface device/transceiver 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 800 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: identify user information received from the device, the user information corresponding to a trajectory of the device as determined by a navigation system of the device; identify external information corresponding to the trajectory of the device, as determined by a wireless network; determine navigation system error by comparing the user information to the external information; and cause to send information associated with the navigation system error to a server.

Example 2 may include the device of example 1 and/or some other example herein, wherein the navigation system error may be determined without the use of a dedicated ground truth reference (GTR) device.

Example 3 may include the device of example 1 and/or some other example herein, wherein the trajectory may include information related to an estimated path of travel of the device.

Example 4 may include the device of example 1 and/or some other example herein, wherein the wireless network comprises one or more WiFi devices or cellular networks.

Example 5 may include the device of example 1 and/or some other example herein, wherein the user information may be based on a global navigation satellite system (GNSS) or sensors associated with the user devices.

Example 6 may include the device of example 1 and/or some other example herein, wherein the navigation system error defines a performance aspect of the navigation system.

Example 7 may include the device of example 1 and/or some other example herein, wherein the navigation system error may be determined using at least one of KL-Divergence, mean-squared error (MSE), and mean-absolute error (MAE).

Example 8 may include the device of example 1 and/or some other example herein, further comprising a transceiver configured to transmit and receive wireless signals associated with the external information.

Example 9 may include the device of example 8 and/or some other example herein, further comprising an antenna coupled to the transceiver to cause to send the information.

Example 10 may include a non-transitory computer-readable medium storing computer-executable instructions which when executed by one or more processors result in performing operations comprising: identifying user information received from the device, the user information corresponding to a trajectory of the device as determined by a navigation system of the device; identifying external information corresponding to the trajectory of the device, as determined by a wireless network; determining navigation system error by comparing the user information to the external information; and causing to send information associated with the navigation system error to a server.

Example 11 may include the non-transitory computer-readable medium of example 10 and/or some other example herein, wherein the navigation system error may be determined without the use of a dedicated ground truth reference (GTR) device.

Example 12 may include the non-transitory computer-readable medium of example 10 and/or some other example herein, wherein the trajectory may include information related to an estimated path of travel of the device.

Example 13 may include the non-transitory computer-readable medium of example 10 and/or some other example herein, wherein the wireless network comprises one or more WiFi devices or cellular networks.

Example 14 may include the non-transitory computer-readable medium of example 10 and/or some other example herein, wherein the user information may be based on a global navigation satellite system (GNSS) or sensors associated with the user devices.

Example 15 may include the non-transitory computer-readable medium of example 10 and/or some other example herein, wherein the navigation system error defines a performance aspect of the navigation system.

Example 16 may include the non-transitory computer-readable medium of example 10 and/or some other example herein, wherein the navigation system error may be determined using at least one of KL-Divergence, mean-squared error (MSE), and mean-absolute error (MAE).

Example 17 may include a method comprising: identifying, by one or more processors user information received from the device, the user information corresponding to a trajectory of the device as determined by a navigation system of the device; identifying external information corresponding to the trajectory of the device, as determined by a wireless network; determining navigation system error by comparing the user information to the external information; and causing to send information associated with the navigation system error to a server.

Example 18 may include the method of example 17 and/or some other example herein, wherein the navigation system error may be determined without the use of a dedicated ground truth reference (GTR) device.

Example 19 may include the method of example 17 and/or some other example herein, wherein the trajectory may include information related to an estimated path of travel of the device.

Example 20 may include the method of example 17 and/or some other example herein, wherein the wireless network comprises one or more WiFi devices or cellular networks.

Example 21 may include the method of example 17 and/or some other example herein, wherein the user information may be based on a global navigation satellite system (GNSS) or sensors associated with the user devices.

Example 22 may include the method of example 17 and/or some other example herein, wherein the navigation system error defines a performance aspect of the navigation system.

Example 23 may include an apparatus comprising means for: identifying user information received from the device, the user information corresponding to a trajectory of the device as determined by a navigation system of the device; identifying external information corresponding to the trajectory of the device, as determined by a wireless network; determining navigation system error by comparing the user information to the external information; and causing to send information associated with the navigation system error to a server.

Example 24 may include the apparatus of example 23 and/or some other example herein, wherein the navigation system error may be determined without the use of a dedicated ground truth reference (GTR) device.

Example 25 may include the apparatus of example 23 and/or some other example herein, wherein the trajectory may include information related to an estimated path of travel of the device.

Example 26 may include the apparatus of example 23 and/or some other example herein, wherein the wireless network comprises one or more WiFi devices or cellular networks.

Example 27 may include the apparatus of example 23 and/or some other example herein, wherein the user information may be based on a global navigation satellite system (GNSS) or sensors associated with the user devices.

Example 28 may include the apparatus of example 23 and/or some other example herein, wherein the navigation system error defines a performance aspect of the navigation system.

Example 29 may include the apparatus of example 23 and/or some other example herein, wherein the navigation system error may be determined using at least one of KL-Divergence, mean-squared error (MSE), and mean-absolute error (MAE).

Example 30 may include the method of example 23 and/or some other example herein, wherein the navigation system error may be determined using at least one of KL-Divergence, mean-squared error (MSE), and mean-absolute error (MAE).

Example 31 may include one or more non-transitory computer-readable media comprising instructions to cause an electronic device, upon execution of the instructions by one or more processors of the electronic device, to perform one or more elements of a method described in or related to any of examples 1-30, or any other method or process described herein.

Example 32 may include an apparatus comprising logic, modules, and/or circuitry to perform one or more elements of a method described in or related to any of examples 1-30, or any other method or process described herein.

Example 33 may include a method, technique, or process as described in or related to any of examples 1-30, or portions or parts thereof.

Example 34 may include an apparatus comprising: one or more processors and one or more computer readable media comprising instructions that, when executed by the one or more processors, cause the one or more processors to perform the method, techniques, or process as described in or related to any of examples 1-30, or portions thereof.

Example 35 may include a method of communicating in a wireless network as shown and described herein.

Example 36 may include a system for providing wireless communication as shown and described herein.

Example 37 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

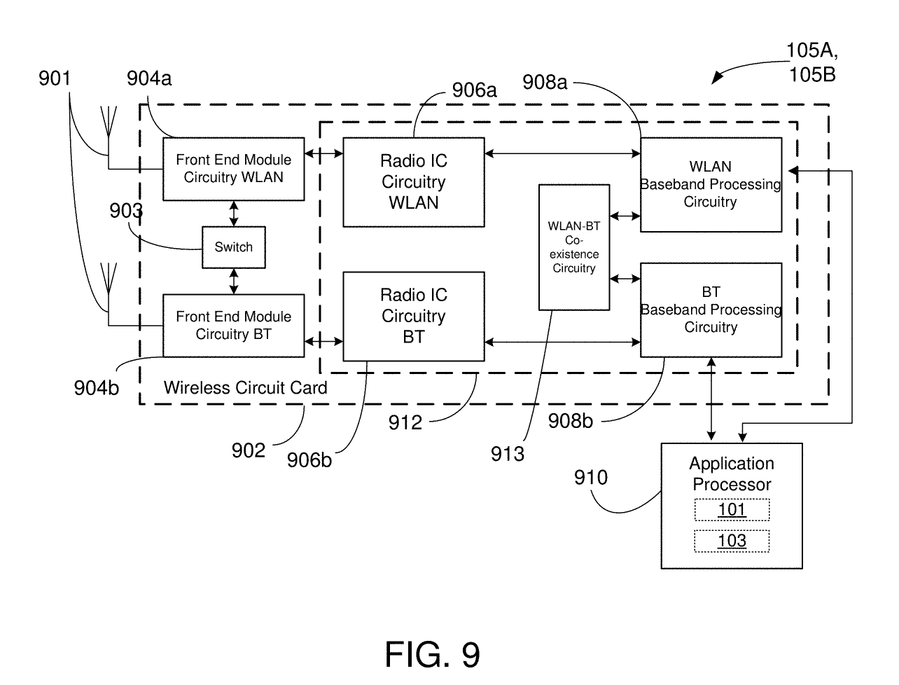

FIG. 9 is a block diagram of a radio architecture 105A, 105B in accordance with some embodiments that may be implemented in any one of the example AP 102 and/or the example user device 120 of FIG. 1. Radio architecture 105A, 105B may include radio front-end module (FEM) circuitry 904a-b, radio IC circuitry 906a-b and baseband processing circuitry 908a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 904a-b may include a WLAN or Wi-Fi FEM circuitry 904a and a Bluetooth (BT) FEM circuitry 904b. The WLAN FEM circuitry 904a may include a receive signal path comprising circuitry configured to operate on WLAN RF signals received from one or more antennas 901, to amplify the received signals and to provide the amplified versions of the received signals to the WLAN radio IC circuitry 906a for further processing. The BT FEM circuitry 904b may include a receive signal path which may include circuitry configured to operate on BT RF signals received from one or more antennas 901, to amplify the received signals and to provide the amplified versions of the received signals to the BT radio IC circuitry 906b for further processing. FEM circuitry 904a may also include a transmit signal path which may include circuitry configured to amplify WLAN signals provided by the radio IC circuitry 906a for wireless transmission by one or more of the antennas 901. In addition, FEM circuitry 904b may also include a transmit signal path which may include circuitry configured to amplify BT signals provided by the radio IC circuitry 906b for wireless transmission by the one or more antennas. In the embodiment of FIG. 9, although FEM 904a and FEM 904b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 906a-b as shown may include WLAN radio IC circuitry 906a and BT radio IC circuitry 906b. The WLAN radio IC circuitry 906a may include a receive signal path which may include circuitry to down-convert WLAN RF signals received from the FEM circuitry 904a and provide baseband signals to WLAN baseband processing circuitry 908a. BT radio IC circuitry 906b may in turn include a receive signal path which may include circuitry to down-convert BT RF signals received from the FEM circuitry 904b and provide baseband signals to BT baseband processing circuitry 908b. WLAN radio IC circuitry 906a may also include a transmit signal path which may include circuitry to up-convert WLAN baseband signals provided by the WLAN baseband processing circuitry 908a and provide WLAN RF output signals to the FEM circuitry 904a for subsequent wireless transmission by the one or more antennas 901. BT radio IC circuitry 906b may also include a transmit signal path which may include circuitry to up-convert BT baseband signals provided by the BT baseband processing circuitry 908b and provide BT RF output signals to the FEM circuitry 904b for subsequent wireless transmission by the one or more antennas 901. In the embodiment of FIG. 9, although radio IC circuitries 906a and 906b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 908a-b may include a WLAN baseband processing circuitry 908a and a BT baseband processing circuitry 908b. The WLAN baseband processing circuitry 908a may include a memory, such as, for example, a set of RAM arrays in a Fast Fourier Transform or Inverse Fast Fourier Transform block (not shown) of the WLAN baseband processing circuitry 908a. Each of the WLAN baseband circuitry 908a and the BT baseband circuitry 908b may further include one or more processors and control logic to process the signals received from the corresponding WLAN or BT receive signal path of the radio IC circuitry 906a-b, and to also generate corresponding WLAN or BT baseband signals for the transmit signal path of the radio IC circuitry 906a-b. Each of the baseband processing circuitries 908a and 908b may further include physical layer (PHY) and medium access control layer (MAC) circuitry, and may further interface with a device for generation and processing of the baseband signals and for controlling operations of the radio IC circuitry 906a-b.

Referring still to FIG. 9, according to the shown embodiment, WLAN-BT coexistence circuitry 913 may include logic providing an interface between the WLAN baseband circuitry 908a and the BT baseband circuitry 908b to enable use cases requiring WLAN and BT coexistence. In addition, a switch 903 may be provided between the WLAN FEM circuitry 904a and the BT FEM circuitry 904b to allow switching between the WLAN and BT radios according to application needs. In addition, although the antennas 901 are depicted as being respectively connected to the WLAN FEM circuitry 904a and the BT FEM circuitry 904b, embodiments include within their scope the sharing of one or more antennas as between the WLAN and BT FEMs, or the provision of more than one antenna connected to each of FEM 904a or 904b.

In some embodiments, the front-end module circuitry 904a-b, the radio IC circuitry 906a-b, and baseband processing circuitry 908a-b may be provided on a single radio card, such as wireless radio card 902. In some other embodiments, the one or more antennas 901, the FEM circuitry 904a-b and the radio IC circuitry 906a-b may be provided on a single radio card. In some other embodiments, the radio IC circuitry 906a-b and the baseband processing circuitry 908a-b may be provided on a single chip or integrated circuit (IC), such as IC 912.

In some embodiments, the wireless radio card 902 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 908b may be compliant with a Bluetooth (BT) connectivity standard such as Bluetooth, Bluetooth 8.0 or Bluetooth 6.0, or any other iteration of the Bluetooth Standard. In

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

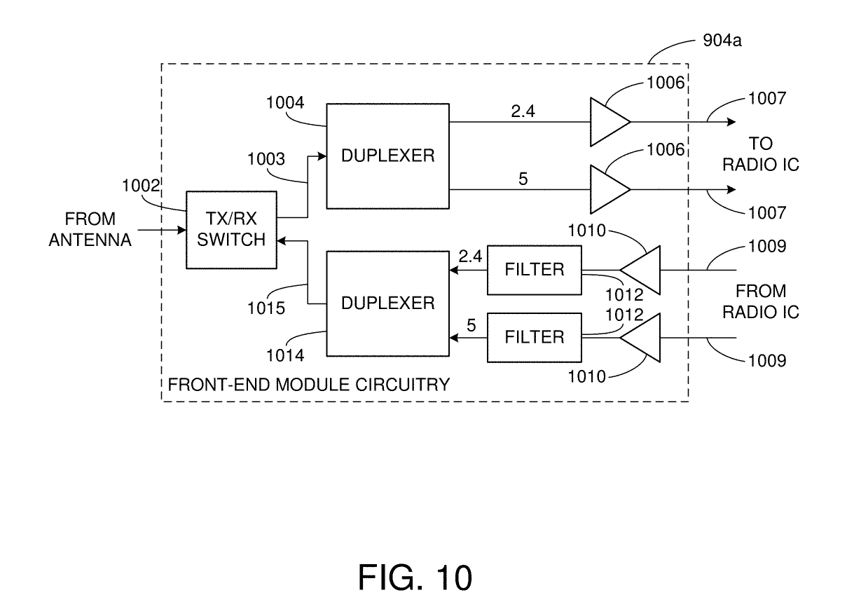

FIG. 10 illustrates WLAN FEM circuitry 904a in accordance with some embodiments. Although the example of FIG. 10 is described in conjunction with the WLAN FEM circuitry 904a, the example of FIG. 10 may be described in conjunction with the example BT FEM circuitry 904b (FIG. 9), although other circuitry configurations may also be suitable.

In some embodiments, the FEM circuitry 904a may include a TX/RX switch 1002 to switch between transmit mode and receive mode operation. The FEM circuitry 904a may include a receive signal path and a transmit signal path. The receive signal path of the FEM circuitry 904a may include a low-noise amplifier (LNA) 1006 to amplify received RF signals 1003 and provide the amplified received RF signals 1007 as an output (e.g., to the radio IC circuitry 906a-b (FIG. 9)). The transmit signal path of the circuitry 904a may include a power amplifier (PA) to amplify input RF signals 1009 (e.g., provided by the radio IC circuitry 906a-b), and one or more filters 1012, such as band-pass filters (BPFs), low-pass filters (LPFs) or other types of filters, to generate RF signals 1015 for subsequent transmission (e.g., by one or more of the antennas 901 (FIG. 9)) via an example duplexer 1014.

In some dual-mode embodiments for Wi-Fi communication, the FEM circuitry 904a may be configured to operate in either the 2.4 GHz frequency spectrum or the 5 GHz frequency spectrum. In these embodiments, the receive signal path of the FEM circuitry 904a may include a receive signal path duplexer 1004 to separate the signals from each spectrum as well as provide a separate LNA 1006 for each spectrum as shown. In these embodiments, the transmit signal path of the FEM circuitry 904a may also include a power amplifier 1010 and a filter 1012, such as a BPF, an LPF or another type of filter for each frequency spectrum and a transmit signal path duplexer 1004 to provide the signals of one of the different spectrums onto a single transmit path for subsequent transmission by the one or more of the antennas 901 (FIG. 9). In some embodiments, BT communications may utilize the 2.4 GHz signal paths and may utilize the same FEM circuitry 904a as the one used for WLAN communications.

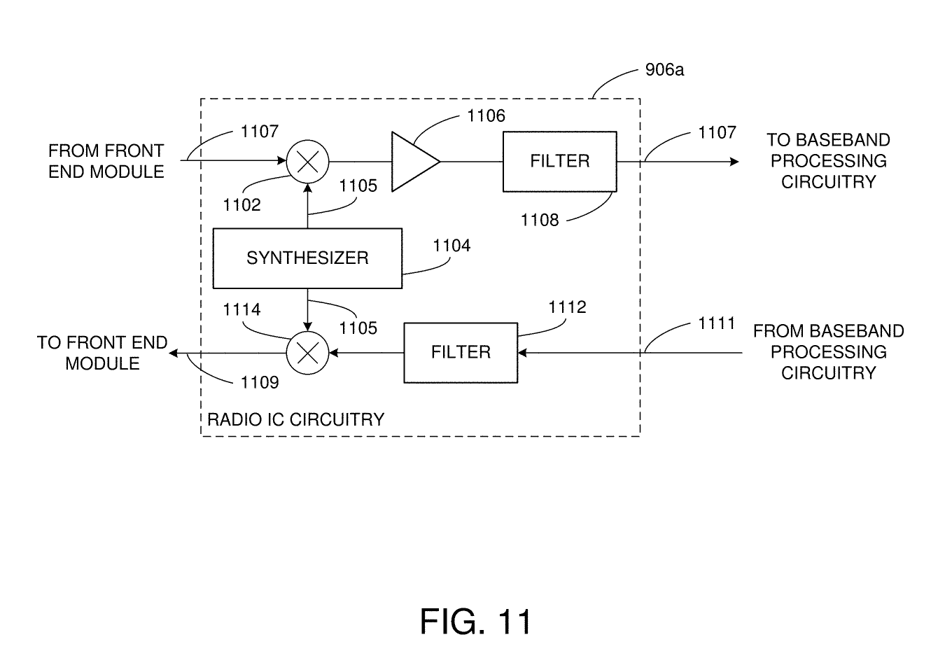

FIG. 11 illustrates radio IC circuitry 906a in accordance with some embodiments. The radio IC circuitry 906a is one example of circuitry that may be suitable for use as the WLAN or BT radio IC circuitry 906a/906b (FIG. 9), although other circuitry configurations may also be suitable. Alternatively, the example of FIG. 11 may be described in conjunction with the example BT radio IC circuitry 906b.

In some embodiments, the radio IC circuitry 906a may include a receive signal path and a transmit signal path. The receive signal path of the radio IC circuitry 906a may include at least mixer circuitry 1102, such as, for example, down-conversion mixer circuitry, amplifier circuitry 1106 and filter circuitry 1108. The transmit signal path of the radio IC circuitry 906a may include at least filter circuitry 1112 and mixer circuitry 1114, such as, for example, up-conversion mixer circuitry. Radio IC circuitry 906a may also include synthesizer circuitry 1104 for synthesizing a frequency 1105 for use by the mixer circuitry 1102 and the mixer circuitry 1114. The mixer circuitry 1102 and/or 1114 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 11 illustrates only a simplified version of a radio IC circuitry, and may include, although not shown, embodiments where each of the depicted circuitries may include more than one component. For instance, mixer circuitry 1114 may each include one or more mixers, and filter circuitries 1108 and/or 1112 may each include one or more filters, such as one or more BPFs and/or LPFs according to application needs. For example, when mixer circuitries are of the direct-conversion type, they may each include two or more mixers.

In some embodiments, mixer circuitry 1102 may be configured to down-convert RF signals 1007 received from the FEM circuitry 904a-b (FIG. 9) based on the synthesized frequency 1105 provided by synthesizer circuitry 1104. The amplifier circuitry 1106 may be configured to amplify the down-converted signals and the filter circuitry 1108 may include an LPF configured to remove unwanted signals from the down-converted signals to generate output baseband signals 1107. Output baseband signals 1107 may be provided to the baseband processing circuitry 908a-b (FIG. 9) for further processing. In some embodiments, the output baseband signals 1107 may be zero-frequency baseband signals, although this is not a requirement. In some embodiments, mixer circuitry 1102 may comprise passive mixers, although the scope of the embodiments is not limited in this respect.

In some embodiments, the mixer circuitry 1114 may be configured to up-convert input baseband signals 1111 based on the synthesized frequency 1105 provided by the synthesizer circuitry 1104 to generate RF output signals 1009 for the FEM circuitry 904a-b. The baseband signals 1111 may be provided by the baseband processing circuitry 908a-b and may be filtered by filter circuitry 1112. The filter circuitry 1112 may include an LPF or a BPF, although the scope of the embodiments is not limited in this respect.

In some embodiments, the mixer circuitry 1102 and the mixer circuitry 1114 may each include two or more mixers and may be arranged for quadrature down-conversion and/or up-conversion respectively with the help of synthesizer 1104. In some embodiments, the mixer circuitry 1102 and the mixer circuitry 1114 may each include two or more mixers each configured for image rejection (e.g., Hartley image rejection). In some embodiments, the mixer circuitry 1102 and the mixer circuitry 1114 may be arranged for direct down-conversion and/or direct up-conversion, respectively. In some embodiments, the mixer circuitry 1102 and the mixer circuitry 1114 may be configured for super-heterodyne operation, although this is not a requirement.

Mixer circuitry 1102 may comprise, according to one embodiment: quadrature passive mixers (e.g., for the in-phase (I) and quadrature phase (Q) paths). In such an embodiment, RF input signal 1007 from FIG. 11 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1105 of synthesizer 1104 (FIG. 11). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1007 (FIG. 10) may comprise a balanced signal, although the scope of the embodiments is not limited in this respect. The I and Q baseband output signals may be provided to low-noise amplifier, such as amplifier circuitry 1106 (FIG. 11) or to filter circuitry 1108 (FIG. 11).

In some embodiments, the output baseband signals 1107 and the input baseband signals 1111 may be analog baseband signals, although the scope of the embodiments is not limited in this respect. In some alternate embodiments, the output baseband signals 1107 and the input baseband signals 1111 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1104 may be a fractional-N synthesizer or a fractional N/N+1 synthesizer, although the scope of the embodiments is not limited in this respect as other types of frequency synthesizers may be suitable. For example, synthesizer circuitry 1104 may be a delta-sigma synthesizer, a frequency multiplier, or a synthesizer comprising a phase-locked loop with a frequency divider. According to some embodiments, the synthesizer circuitry 1104 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1104 may be provided by a voltage controlled oscillator (VCO), although that is not a requirement. A divider control input may further be provided by either the baseband processing circuitry 908a-b (FIG. 9) depending on the desired output frequency 1105. In some embodiments, a divider control input (e.g., N) may be determined from a look-up table (e.g., within a Wi-Fi card) based on a channel number and a channel center frequency as determined or indicated by the example application processor 910. The application processor 910 may include, or otherwise be connected to, one of the example secure signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (fLO).

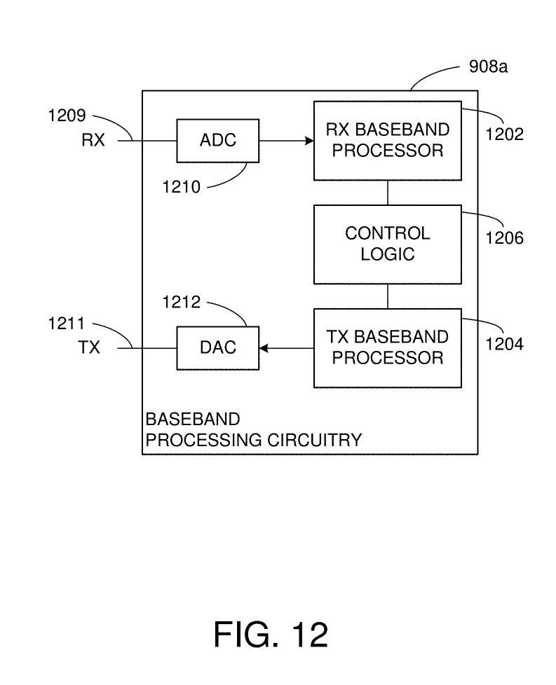

FIG. 12 illustrates a functional block diagram of baseband processing circuitry 908a in accordance with some embodiments. The baseband processing circuitry 908a is one example of circuitry that may be suitable for use as the baseband processing circuitry 908a (FIG. 9), although other circuitry configurations may also be suitable. Alternatively, the example of FIG. 11 may be used to implement the example BT baseband processing circuitry 908b of FIG. 9.

The baseband processing circuitry 908a may include a receive baseband processor (RX BBP) 1202 for processing receive baseband signals 1109 provided by the radio IC circuitry 906a-b (FIG. 9) and a transmit baseband processor (TX BBP) 1204 for generating transmit baseband signals 1111 for the radio IC circuitry 906a-b. The baseband processing circuitry 908a may also include control logic 1206 for coordinating the operations of the baseband processing circuitry 908a.

In some embodiments (e.g., when analog baseband signals are exchanged between the baseband processing circuitry 908a-b and the radio IC circuitry 906a-b), the baseband processing circuitry 908a may include ADC 1210 to convert analog baseband signals 1209 received from the radio IC circuitry 906a-b to digital baseband signals for processing by the RX BBP 1202. In these embodiments, the baseband processing circuitry 908a may also include DAC 1212 to convert digital baseband signals from the TX BBP 1204 to analog baseband signals 1211.

In some embodiments that communicate OFDM signals or OFDMA signals, such as through baseband processor 908a, the transmit baseband processor 1204 may be configured to generate OFDM or OFDMA signals as appropriate for transmission by performing an inverse fast Fourier transform (IFFT). The receive baseband processor 1202 may be configured to process received OFDM signals or OFDMA signals by performing an FFT. In some embodiments, the receive baseband processor 1202 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 9, in some embodiments, the antennas 901 (FIG. 9) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 901 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

What is claimed is:

1. A device, the device comprising processing circuitry coupled to storage, the processing circuitry configured to:
identify user information received from the device, the user information corresponding to a trajectory of the device as determined by a navigation system of the device;
identify external information corresponding to the trajectory of the device, as determined by a wireless network;
determine navigation system error by comparing the user information to the external information; and
cause to send information associated with the navigation system error to a server.

2. The device of claim 1, wherein the navigation system error is determined without the use of a dedicated ground truth reference (GTR) device.

3. The device of claim 1, wherein the trajectory includes information related to an estimated path of travel of the device.

4. The device of claim 1, wherein the wireless network comprises one or more WiFi devices or cellular networks.

5. The device of claim 1, wherein the user information is based on a global navigation satellite system (GNSS) or sensors associated with the user devices.

6. The device of claim 1, wherein the navigation system error defines a performance aspect of the navigation system.

7. The device of claim 1, wherein the navigation system error is determined using at least one of KL-Divergence, mean-squared error (MSE), and mean-absolute error (MAE).

8. The device of claim 1, further comprising a transceiver configured to transmit and receive wireless signals associated with the external information.

9. The device of claim 8, further comprising an antenna coupled to the transceiver to cause to send the information.

10. A non-transitory computer-readable medium storing computer-executable instructions which when executed by one or more processors result in performing operations comprising:
identifying user information received from the device, the user information corresponding to a trajectory of the device as determined by a navigation system of the device;
identifying external information corresponding to the trajectory of the device, as determined by a wireless network;
determining navigation system error by comparing the user information to the external information; and
causing to send information associated with the navigation system error to a server.

11. The non-transitory computer-readable medium of claim 10, wherein the navigation system error is determined without the use of a dedicated ground truth reference (GTR) device.

12. The non-transitory computer-readable medium of claim 10, wherein the trajectory includes information related to an estimated path of travel of the device.

13. The non-transitory computer-readable medium of claim 10, wherein the wireless network comprises one or more WiFi devices or cellular networks.

14. The non-transitory computer-readable medium of claim 10, wherein the user information is based on a global navigation satellite system (GNSS) or sensors associated with the user devices.

15. The non-transitory computer-readable medium of claim 10, wherein the navigation system error defines a performance aspect of the navigation system.

16. The non-transitory computer-readable medium of claim 10, wherein the navigation system error is determined using at least one of KL-Divergence, mean-squared error (MSE), and mean-absolute error (MAE).

17. A method comprising:
identifying, by one or more processors user information received from the device, the user information corresponding to a trajectory of the device as determined by a navigation system of the device;
identifying external information corresponding to the trajectory of the device, as determined by a wireless network;
determining navigation system error by comparing the user information to the external information; and
causing to send information associated with the navigation system error to a server.

18. The method of claim 17, wherein the navigation system error is determined without the use of a dedicated ground truth reference (GTR) device.

19. The method of claim 17, wherein the trajectory includes information related to an estimated path of travel of the device.

20. The method of claim 17, wherein the wireless network comprises one or more WiFi devices or cellular networks.
